(19) United States
(12) Patent Application Publication
(10) Pub. No.: US 2025/0335259 A1
(43) Pub. Date: Oct. 30, 2025

(54) COMPUTATIONAL RESOURCE MANAGEMENT IN AN INFORMATION PROCESSING SYSTEM

(71) Applicant: Dell Products L.P., Round Rock, TX (US)

(72) Inventors: Dhilip S. Kumar, Bangalore (IN); Mahendra G. Babu, Bangalore (IN); Shibi Panikkar, Bangalore (IN)

(21) Appl. No.: 18/647,251

(22) Filed: Apr. 26, 2024

(51) Int. Cl. G06F 9/50; G06F 9/455

(52) U.S. Cl. CPC G06F 9/5044; G06F 9/45558; G06F 9/5066; G06F 2009/45562; G06F 2209/503

(57) ABSTRACT

Techniques are disclosed for computational resource management in information processing systems. For example, a method receives a request to execute a task. The method manages execution of the task via one or more computational resources of a plurality of computational resources ordinarily used for executing other tasks. Managing execution of the task may further include receiving one or more parameters representing one or more of a consent, a time period availability, and a computational resource capacity from each of the plurality of computational resources, and identifying the one or more computational resources of the plurality of computational resources able to execute the task based on the one or more parameters.

### FIELD

The field relates generally to information processing systems, and more particularly to techniques for computational resource management in such information processing systems.

### BACKGROUND

It is realized that society has entered a new technological cycle based on a digital economy. This new technological cycle is propelled by the combination of many different technologies including, by way of example only, artificial intelligence, 5G telecommunications, quantum computation, big data, and blockchain, to name a few. Accordingly, enterprises and other entities have begun to understand that in a digital economy era, computational resource capacity is one of the most essential and innovation-driving sources of productivity.

### SUMMARY

Illustrative embodiments provide techniques for computational resource management in information processing systems. While techniques illustratively described herein are particularly well-suited for enterprise management of computational resources of employees, the techniques are more broadly applicable to a wide variety of other information processing systems.

For example, in one or more illustrative embodiments, a method receives a request to execute a task. The method manages execution of the task via one or more computational resources of a plurality of computational resources ordinarily used for executing other tasks. Managing execution of the task may further include receiving one or more parameters representing one or more of a consent, a time period availability, and a computational resource capacity from each of the plurality of computational resources, and identifying the one or more computational resources of the plurality of computational resources able to execute the task based on the one or more parameters.

These and other illustrative embodiments include, without limitation, methods, apparatus, networks, systems and processor-readable storage media.

### BRIEF DESCRIPTION OF THE DRAWINGS

FIG. 1 illustrates an information processing system with computational resource management functionalities according to an illustrative embodiment.

FIG. 2 illustrates an information processing system with a computational resource management engine architecture according to an illustrative embodiment.

FIG. 3 illustrates an information processing system with further details of a computational resource management engine architecture according to an illustrative embodiment.

FIG. 4A illustrates a job registration example associated with a computational resource management engine architecture according to an illustrative embodiment.

FIG. 4B illustrates a device registration example associated with a computational resource management engine architecture according to an illustrative embodiment.

FIG. 5 illustrates a clustering example associated with a computational resource management engine architecture according to an illustrative embodiment.

FIG. 6 illustrates a calibration example associated with a computational resource management engine architecture according to an illustrative embodiment.

FIG. 7 illustrates a process associated with a computational resource management engine architecture according to an illustrative embodiment.

FIG. 8 illustrates another process associated with a computational resource management engine architecture according to an illustrative embodiment.

FIG. 9 illustrates a further process associated with a computational resource management engine architecture according to an illustrative embodiment.

FIG. 10 illustrates a computational resource management methodology according to an illustrative embodiment.

FIGS. 11 and 12 illustrate examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, processing systems comprising compute, storage and/or network resources, other types of processing systems comprising various combinations of physical and/or virtual resources, as well as other types of distributed computer networks.

As mentioned, in a digital economy era, computational resource capacity (e.g., computational resources including, but not limited to, processing devices, storage devices, network devices, etc.) is one of the most essential and innovation-driving sources of productivity. An organization or some other enterprise addresses the need for additional computing power by continually incorporating more compute nodes into their server racks. It is realized, however, that in a sizable organization, each employee utilizes a laptop or desktop (employee device) equipped with a random access memory (RAM) capacity of 8 to 16 GB (gigabytes). Assuming an average of 12 GB per employee device, organizations with 1000 employees possess a cumulative capacity of 12,000 GB of storage resource with all employees. Although employees work for a certain number of hours per day, for the remaining time, these computational resources are either underutilized or entirely unused.

Further, it is realized that enterprises have numerous software scheduled jobs (tasks) to be executed, and typically dedicated server compute power is used to execute such jobs. However, dedicated servers need to be upgraded as the compute power demand increases. If the dedicated server does not have the needed compute power, this may cause stoppages in execution of the scheduled jobs and/or cause occurrences of out-of-memory exceptions.

Still further, when compute power in the dedicated server is utilized to process the scheduled job, other important workloads that the server may otherwise need to execute may be adversely affected. Moreover, in the dedicated server scenario, there may be limitations on the number of parallel processes that can be performed due to limited RAM.

Illustrative embodiments overcome the above and other technical drawbacks associated with existing systems that rely on dedicated servers to perform computational tasks (jobs) by providing techniques for harnessing computational resources, in addition to or other than the dedicated servers, to execute scheduled jobs under management of a computational resource management engine.

In some enterprise-based embodiments, such a computational resource management engine enables employee laptops/desktops (examples of compute nodes, computers, employee devices, or the like) to be registered for workload pooling along with operator/user (e.g., employee) consent and operator/user-specified allowable time period of use. In some embodiments, the computational resource management engine deploys a client-side module (e.g., edge agent) and a virtualization image (e.g., container, virtual machine, or the like) for the job to execute in one or more of the laptops/desktops. Further, the computational resource management engine calibrates the compute power requirement for a specific job. When a dedicated task server requests execution of a specific job, the computational resource management engine uses intelligent clustering techniques, based on a policy, to efficiently determine the compute power from employee laptops/desktops available at that time and/or another time. Once the job is executed, the computational resource management engine aggregates the executed data details from the employee laptops/desktops and updates the task server.

While techniques illustratively described herein are particularly well-suited for enterprise management of computational resources of employees, techniques are more broadly applicable to a wide variety of other information processing systems.

Referring initially to FIG. 1, an information processing system 100 with computational resource management functionalities according to one or more illustrative embodiments is illustrated. As shown, information processing system 100 includes a computational resource management engine 102, a task server 104, and a plurality of compute nodes 106-1, . . . , 106-N (hereinafter collectively referred to as compute nodes 106 and individually referred to as compute node 106), operatively coupled to each other via one or more communication networks 110.

In some embodiments, information processing system 100 may be considered an enterprise-based information processing system wherein compute nodes 106 include employee devices such as, by way of example, laptops, desktops, and/or other computers or computing devices that the employee ordinarily uses as part of the employee's daily responsibilities for the enterprise. Task server 104 represents a dedicated server or other computing device that manages tasks associated with operations of the enterprise. Computational resource management engine 102 is configured with computational resource management functionalities as will be further described herein. One or more communication networks 110 can be any network (e.g., a public network, a private network, and combinations thereof) that enables computational resource management engine 102, task server 104, and compute nodes 106 to communicate.

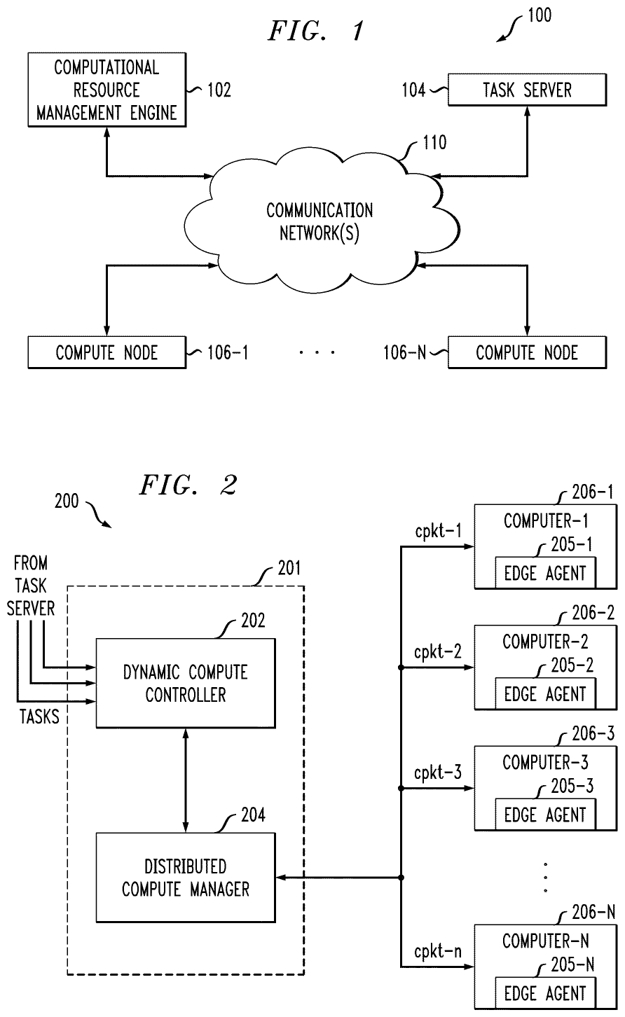

FIG. 2 illustrates an information processing system 200 with a computational resource management engine architecture 201 according to an illustrative embodiment. More particularly, computational resource management engine architecture 201 includes a dynamic compute controller 202 operatively coupled to a distributed compute manager 204. Computational resource management engine architecture 201 is an example of computational resource management engine 102 in FIG. 1.

Dynamic compute controller 202, inter alia, receives tasks from a task server (e.g., task server 104 in FIG. 1), while distributed compute manager 204, inter alia, functions as a pool manager and is operatively coupled to a plurality of edge agents 205-1, 205-2, 205-3, . . . , 205-N (hereinafter collectively referred to as edge agents 205 and individually referred to as edge agent 205) that respectively reside in a plurality of computer 206-1, 206-2, 206-3, . . . , 206-N (hereinafter collectively referred to as computers 206 and individually referred to as computer 206). Note that computers 206 are examples of compute nodes 106 in FIG. 1, e.g., employee laptops/desktops.

More particularly, dynamic compute controller 202 is configured to perform operations including, but not limited to, job registration, device (computer, compute node, etc.) registration, job classification, device classification, and job calibration, as will be further described herein. Once these operations are executed, resulting information is passed to distributed compute manager 204 which is configured to determine the one or more computers 206 that are best suited (e.g., optimal) for executing the given task or job (including dividing the job, if needed, among multiple computers 206), deploy (or otherwise cause deployment of) a virtualized container for executing the job in the one or more computers 206, aggregate the one or more responses from the one or more computers 206 that executed the job, and provide the aggregated response to dynamic compute controller 202 for return to the task server (or return the aggregated response directly to the task server).

Edge agents 205 in each computer 206, inter alia, receive a job execution request from distributed compute manager 204, execute the job in the deployed virtualized container, and send results back to distributed compute manager 204. Distributed compute manager 204 also monitors a heartbeat from edge agent 205 of each computer 206 and also receives consent (via edge agent 205) from the respective operators/users (e.g., employees) of computers 206 to permit assignment of jobs to computers 206. Distributed compute manager 204 also receives notification from the operators/users (via each edge agent 205) that their corresponding computer 206 is ready for the job and how long the corresponding computer 206 is available to execute the job. Consent and/or time-of-use parameters may alternatively be automatically sent by edge agent 205 of each computer 206 when previously approved by the operator/user.

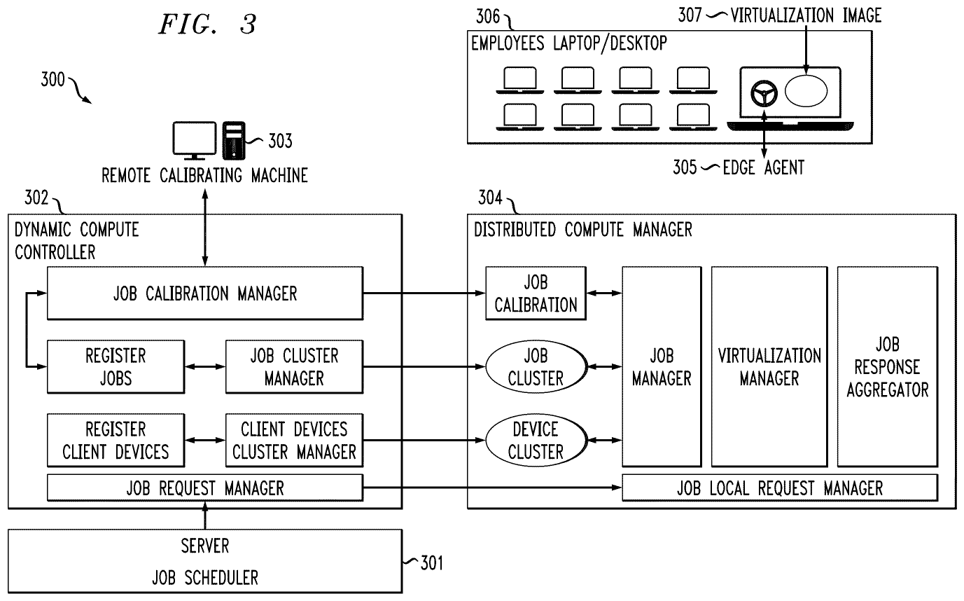

FIG. 3 illustrates an information processing system 300 with further details of a computational resource management engine architecture according to an illustrative embodiment. As shown, a server 301 (example of task server 104 in FIG. 1) is operatively coupled to a dynamic compute controller 302 (example of dynamic compute controller 202 in FIG. 2). A remote calibrating machine 303 is operatively coupled to dynamic compute controller 302. Dynamic compute controller 302 is also operatively coupled to a distributed compute manager 304 (example of distributed compute manager 204 in FIG. 2). Distributed compute manager 304 is operatively coupled to employee laptops/desktops 306 (example of computers 206 in FIG. 2) each which includes an edge agent 305 (example of edge agent 205 in FIG. 2) and a virtualization image 307 (e.g., virtualized environment, virtualized container, virtual machine, or some other virtual processing unit) to execute a job.

In some embodiments, dynamic compute controller 302 is configured to:
1. Register the scheduled jobs that are to be executed (as received from a job scheduler of server 301).
2. Register employee laptops/desktops 306 (also referred to herein as employee devices 306) for compute pooling.
3. Classify the jobs based on the time to execute into job clusters.
4. Classify each registered computer based on the availability, compute power (RAM), and operating system into a device cluster.
5. Establish a proposed relationship between job clusters and device clusters.
6. Calibrate a registered job to determine a compute power capacity needed to execute a single job run. Remote calibrating machine 303 may be used in conjunction with a job calibration manager in dynamic compute controller 302 to perform all or part of the job calibration functionalities, as will be further described below.
7. Store the virtualization image 307 for each job to be executed. More than one job can use the same virtualization image 307 according to the technology required to run the job.

In some embodiments, there can be more than one instance of distributed compute manager 304 depending on the geographic or logical layout of the computational resource management engine architecture. In such a scenario, each distributed compute manager 304 is operatively coupled to dynamic compute controller 302. Accordingly, in some embodiments, each distributed compute manager 304 is configured to:
1. Identify appropriate computers (employee laptops/desktops 306) to execute the job from the job cluster and device cluster.
2. Divide the job, when necessary or desired, into multiple workloads according to device availability.
3. Establish remote connection to the employee laptops/desktops 306 via the respective edge agents 305.
4. Deploy the virtualization image(s) 307 to run the workload(s) so that the virtualization image(s) 307 can be installed in the employee laptops/desktops 306 via the respective edge agents 305.
5. Cause execution of the job remotely in the employee laptops/desktops 306.
6. Receive results back from the employee laptops/desktops 306 and aggregate results once all parallel processing is completed.
7. Notify and send aggregated results to the requester of the job execution (e.g., server 301 and/or dynamic compute controller 302).

In some embodiments, each edge agent 305 is configured to:
1. Maintain a heartbeat signal with distributed compute manager 304.
2. Send the operator/user consent, when the employee laptops/desktop 306 is ready to take job requests, or in advance as may be appropriate, along with a time period of use.
3. Execute the incoming request in the installed virtualization image 307.
4. Send job execution results back to distributed compute manager 304.

It is to be appreciated that the ordering of the above steps/actions respectively performed by dynamic compute controller 302, distributed compute manager 304, and edge agents 305 are intended to be illustrative and thus, in other embodiments, ordering may be different.

Registering and clustering of jobs and employee devices, as performed by dynamic compute controller 302, will now be further described based on an illustrative use case below.

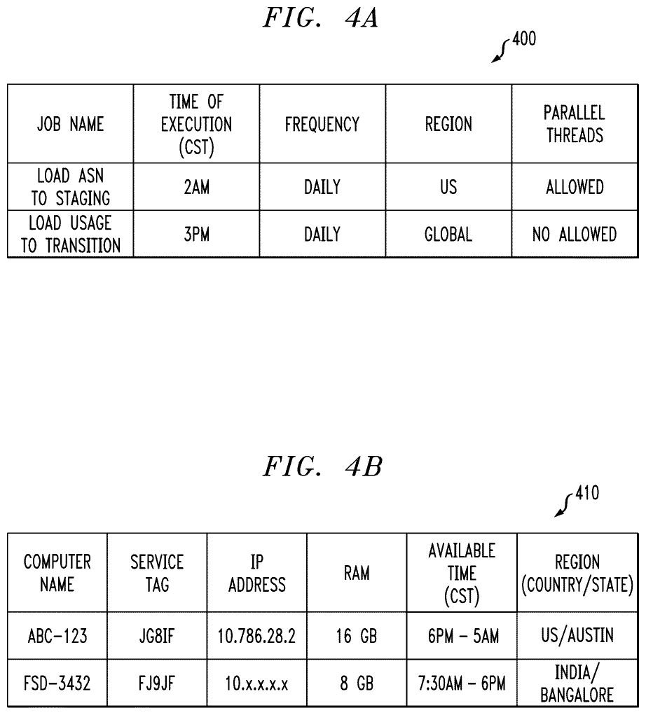

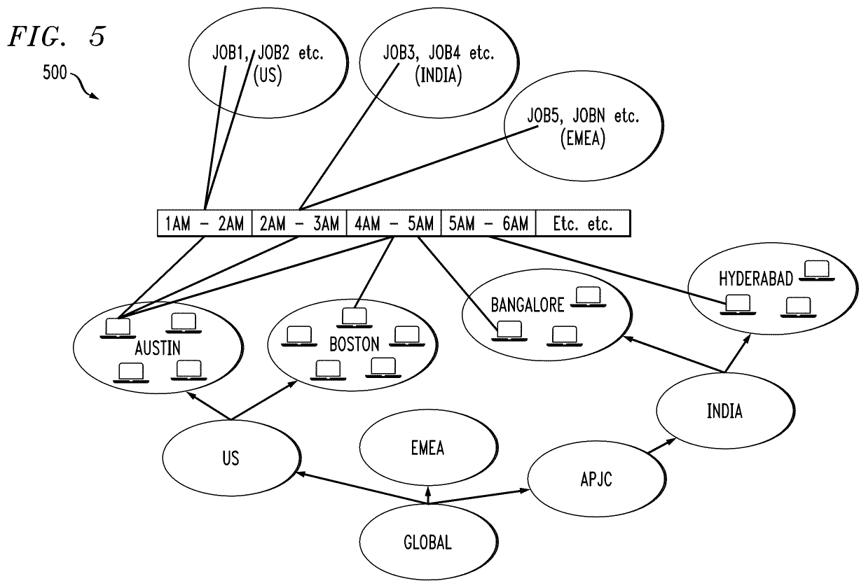

As mentioned, dynamic compute controller 302 registers the jobs to be executed with time and frequency and the employee devices 306 that are available. FIG. 4A illustrates a job registration example in a table 400, while FIG. 4B illustrates a device registration example in a table 410.

In some embodiments, jobs are clustered based on the time to execute and geographical region. FIG. 5 shows a clustering example 500 where devices are clustered in a hierarchical manner from global→region→country→state (i.e., in a U.S.-based implementation). For example, in each state, one distributed compute manager 304 may be deployed to communicate with the employee devices 306 in that state using a local area network (LAN) or other communication network(s).

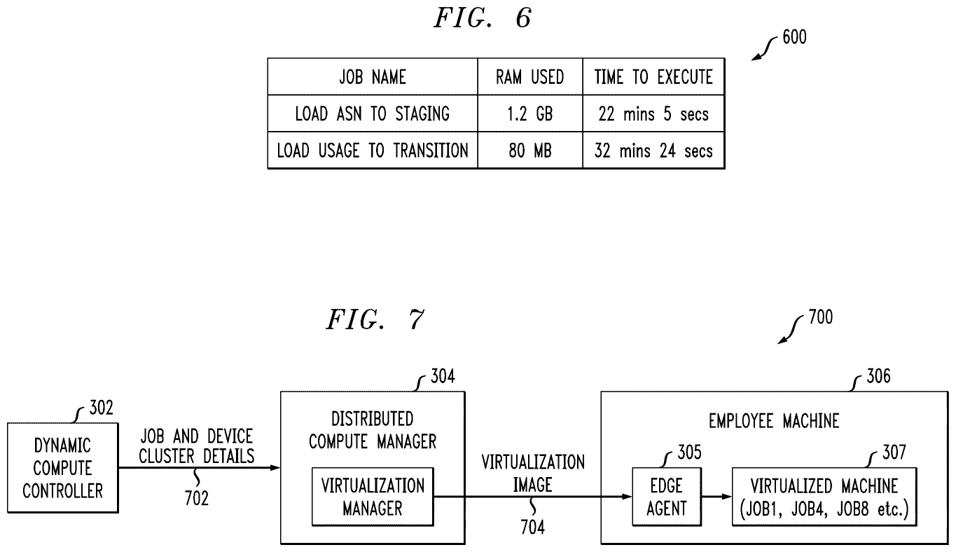

Once the job is registered, in some embodiments, dynamic compute controller 302 performs the first few (e.g., one, two, three, or so) runs of the job using remote calibrating machine 303 to determine the computational resources (e.g., RAM) required to execute the job, as well as recording the time to execute the job. FIG. 6 illustrates a table 600 with an example of calibration data collected by dynamic compute controller 302.

For each job to run, certain technology and infrastructure is needed. As mentioned, distributed compute manager 304 creates the virtualization image 307 that represents the container or virtual machine (VM) that is deployed to the employee device 306. This virtualization image 307 contains the logic and job code to run the job. Note that a single virtualization image 307 can represent multiple jobs. When the employee device 306 is registered and the job clustering is done, the virtualization image 307 (e.g., container, VM, etc.) is installed in the employee device 306 via edge agent 305. FIG. 7 summarizes this sequence of steps as a process 700. As shown, dynamic compute controller 302 provides the job and device cluster details to distributed compute manager 304 in step 702. A virtualization manager in distributed compute manager 304 generates the virtualization image 307 and sends the virtualization image 307 to the employee device (laptop/desktop or, more generally, machine) 306, in step 704, via edge agent 305. In the FIG. 7 example, the virtualization image 307 can be considered a virtualized machine which includes the one or more jobs (e.g., Job 1, Job4, Job8, etc.) and the logic to execute the one or more jobs.

By way of example, assume a new job is registered and clustered, and that the job needs to be run at 5 PM CST. The job is calibrated and the compute power assessed to be needed is 1.5 GB and the maximum time to execute is 128 minutes and 23 seconds.

Further, assume the employee devices 306 are previously clustered according to compute power (e.g., RAM) and the time window that is available. Assume 10,000 employee devices 306 are in the region of which 4,500 are available to execute from 5 PM to 8 PM according to the job calibration.

Distributed compute manager 304 can check whether there are employee devices 306 within the 4,500 available in the time period with less than some configurable threshold number (e.g., three) of virtualization images 307 installed. The configurable threshold number ensures that employee devices 306 are not overloaded with the stored virtualization images 307. Assume that 3,800 of the 4,500 employee devices 306 qualify based on the configurable threshold number.

Distributed compute manager 304 can then check a configuration file (previously generated based on a policy decided on by the enterprise) to obtain the maximum number of employee devices 306 allowed for a single job, e.g., assume, 50.

Thus, from 3,800 employee devices 306, 50 are selected and install the virtualization image 307 for the job. In some embodiments, the job will not run until a job trigger is received, as described below. Note that, until triggered to execute, the virtualization image 307 will take up only storage space in the employee device 306. Also, in some embodiments, virtualization image 307 can be streamed on demand, contemporaneous with the time of execution, from distributed compute manager 304 to edge agent 305 of the employee device 306. The 50 employee devices 306 are marked for the job in the job cluster by dynamic compute controller 302.

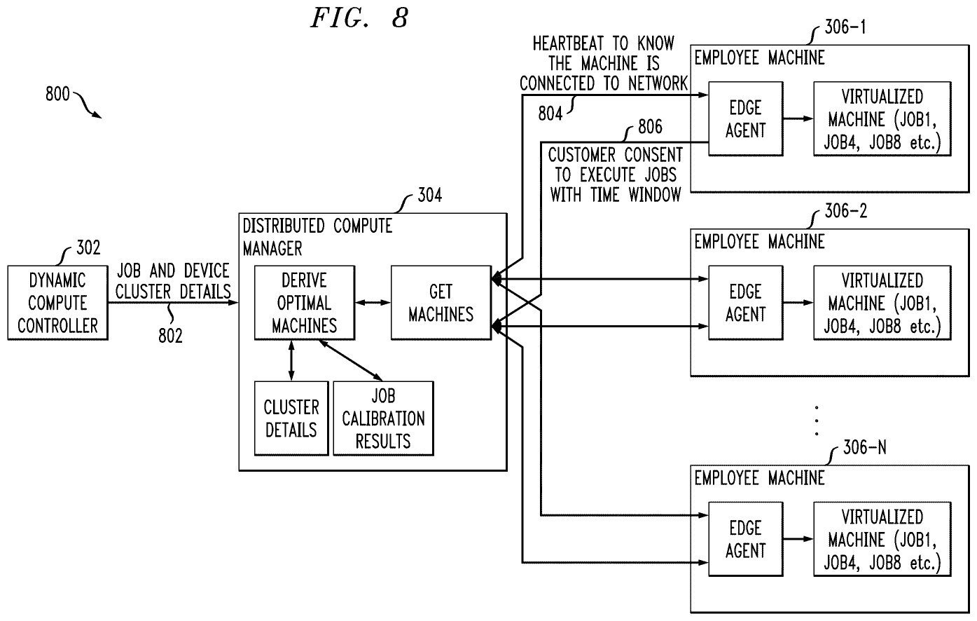

FIG. 8 summarizes a sequence of steps as a process 800 for determining the best-suited (e.g., optimal) available employee devices 306 (306-1, 306-2, . . . 306-N) for executing the incoming job request. In step 802, dynamic compute controller 302 passes the job request along with job and cluster details to distributed compute manager 304. Distributed compute manager 304 first checks, for this specific job, how many employee devices 306 are available to execute according to the region and country, e.g., assume the job needs to execute in Region A, distributed compute manager 304 finds the available employee devices 306 in Region A at that point of time.

Each edge agent 305 sends a heartbeat signal (e.g., step 804) and operator/user (e.g., employee) consent for the given time period to execute the job (e.g., step 806) to distributed compute manager 304, so that distributed compute manager 304 now knows which employee devices (employee machines) 306 are available for the job execution.

From the calibration results for that job, distributed compute manager 304 checks how much RAM is required for the job to run and filters out the employee devices 306 that do not qualify. Further, from the calibration result, distributed compute manager 304 checks the time to execute the job and filters out the employee devices 306 that do not qualify.

Distributed compute manager 304 divides the job into many parallel jobs, when parallel execution is allowed or otherwise desired/needed. For example, assume the job needs to execute 15,000 rows of data in a relational database and the available number of employee devices 306 in that region is 1500. Then, the job is divided into 10 rows going to each of the 1500 employee devices 306. If the number of available employee devices 306 are more than the minimum workload division needed, then the remaining employee devices 306 are discarded from consideration.

Distributed compute manager 304 sends the commands to the edge agents 305 of the 1500 employee devices 306 with the boundary of execution, e.g., 30 minutes prior to the execution time.

Each edge agent 305 receives the request for the job and checks whether the virtualization image 307 for that job is available in its corresponding employee device 306. If not, edge agent 305 can download the virtualization image 307 from distributed compute manager 304. If there is an initialization issue with the virtualization image 307, the edge agent 305 notifies distributed compute manager 304, and distributed compute manager 304 selects another employee device 306. Once the virtualization image 307 for that job is available in the employee device 306, edge agent 305 gives a trigger command to execute the job at the time of the job schedule.

Once the job is executed, execution results from each employee device 306 are aggregated in distributed compute manager 304. Distributed compute manager 304 then sends the execution results to dynamic compute controller 302 or directly to the task server.

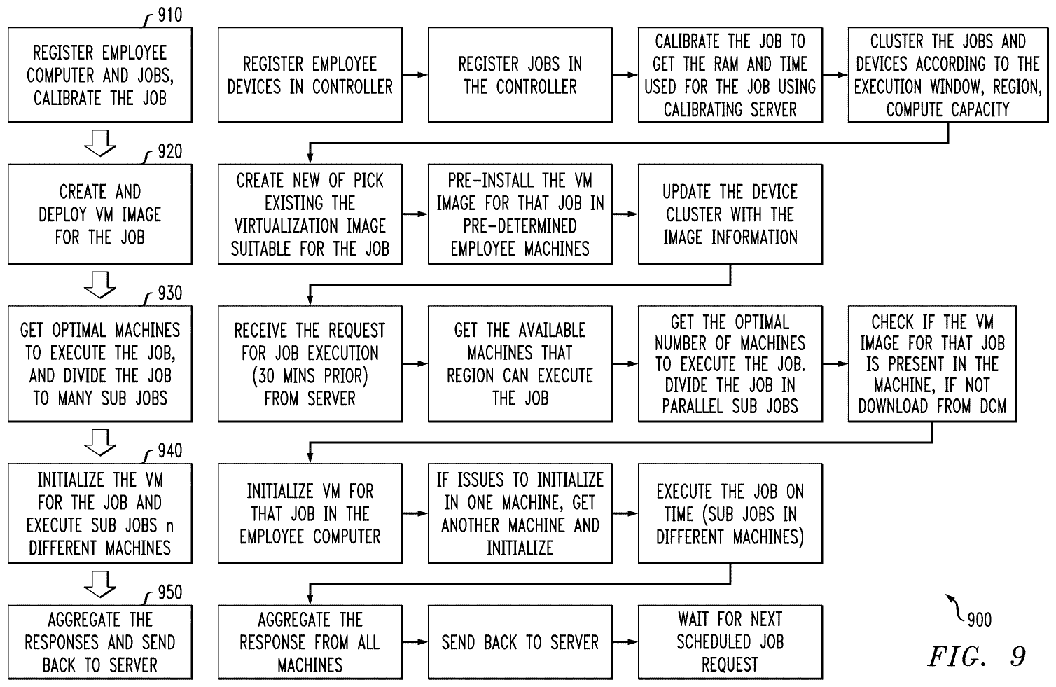

FIG. 9 summarizes the above-described steps in FIGS. 7 and 8, as well as other steps, in a process 900 performed by a computational resource management engine according to one or more illustrative embodiments. As shown, step 910 registers employee computers and jobs, and calibrates a given job. Step 920 creates and deploys a virtual machine image for the job. Step 930 identifies the optimal machines to execute the job, and divides the job into multiple (n) sub jobs. Step 940 initializes the virtual machine for the job and executes the n sub jobs in n different machines, respectively. Step 950 aggregates the responses and sends an aggregated response to the server.

FIG. 10 illustrates a computational resource management methodology 1000 according to an illustrative embodiment. As shown, step 1002 receives a request to execute a task. Step 1004 manages execution of the task via one or more computational resources of a plurality of computational resources ordinarily used for executing other tasks. Managing execution of the task may further include receiving one or more parameters representing one or more of a consent, a time period availability, and a computational resource capacity from each of the plurality of computational resources, and identifying the one or more computational resources of the plurality of computational resources able to execute the task based on the one or more parameters.

In some embodiments, managing execution of the task may further include registering the task and the plurality of computational resources.

In some embodiments, managing execution of the task may further include clustering the task and the plurality of computational resources based on clustering criteria.

In some embodiments, managing execution of the task may further include calibrating the task to determine a minimum computational resource capacity and a maximum time to execute the task such that the identification of the one or more computational resources of the plurality of computational resources is further based on the calibration.

In some embodiments, managing execution of the task may further include causing deployment of a module on each of the plurality of computational resources, wherein the module is configured to facilitate managing execution of the task.

In some embodiments, managing execution of the task may further include causing deployment of a virtualization image on each of the one or more identified computational resources, wherein the virtualization image is configured to execute the task on each of the one or more identified computational resources.

In some embodiments, managing execution of the task may further include dividing the task into sub tasks for parallel execution on the one or more identified computational resources.

In some embodiments, managing execution of the task may further include receiving a heartbeat signal from each of the plurality of computational resources.

In some embodiments, managing execution of the task may further include aggregating results of execution of the task received from the one or more identified computational resources, and sending the aggregated results of execution to a source of the task request.

In some embodiments, the task is associated with an enterprise and the plurality of computational resources are devices respectively operated by employees of the enterprise such that the one or more identified computational resources are utilized to execute the task when the one or more identified computational resources are available based on the other tasks the one or more identified computational resources are ordinarily used for execute.

In some embodiments, at least one processing platform is configured with a dynamic compute controller and at least one distributed compute managers operatively coupled to the dynamic compute controller.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

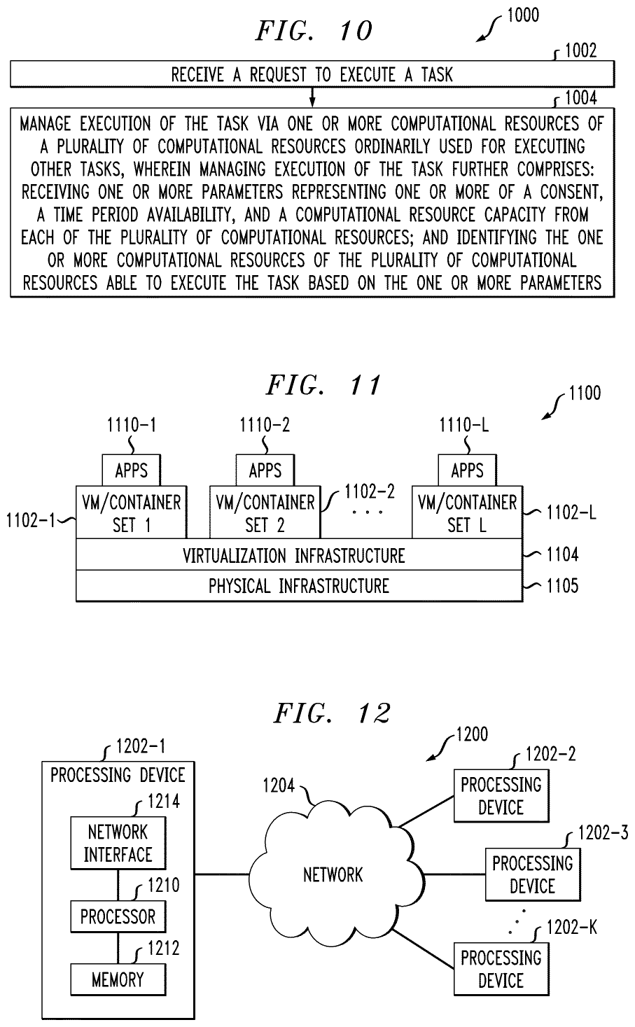

Illustrative embodiments of processing platforms utilized to implement functionality for multi-modal data distribution functionalities will now be described in greater detail with reference to FIGS. 11 and 12. Although described in the context of information processing system environment mentioned herein, these platforms may also be used to implement at least portions of other information processing systems in other embodiments.

FIG. 11 shows an example processing platform comprising infrastructure 1100. Infrastructure 1100 comprises a combination of physical and virtual processing resources that may be utilized to implement at least a portion of the information processing systems described herein. Infrastructure 1100 comprises multiple virtual machines (VMs) and/or container sets 1102-1, 1102-2, . . . 1102-L implemented using virtualization infrastructure 1104. The virtualization infrastructure 1104 runs on physical infrastructure 1105, and illustratively comprises one or more hypervisors and/or operating system level virtualization infrastructure. The operating system level virtualization infrastructure illustratively comprises kernel control groups of a Linux operating system or other type of operating system.

Infrastructure 1100 further comprises sets of applications 1110-1, 1110-2, . . . 1110-L running on respective ones of the VMs/container sets 1102-1, 1102-2, . . . 1102-L under the control of the virtualization infrastructure 1104. The VMs/container sets 1102 may comprise respective VMs, respective sets of one or more containers, or respective sets of one or more containers running in VMs.

In some implementations of the FIG. 11 embodiment, the VMs/container sets 1102 comprise respective VMs implemented using virtualization infrastructure 1104 that comprises at least one hypervisor. A hypervisor platform may be used to implement a hypervisor within the virtualization infrastructure 1104, where the hypervisor platform has an associated virtual infrastructure management system. The underlying physical machines may comprise one or more distributed processing platforms that include one or more storage systems.

In other implementations of the FIG. 11 embodiment, the VMs/container sets 1102 comprise respective containers implemented using virtualization infrastructure 1104 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system environments mentioned herein may each run on a computer, server, storage device or other processing platform element. A given such element may be viewed as an example of what is more generally referred to herein as a “processing device.” Infrastructure 1100 shown in FIG. 11 may represent at least a portion of one processing platform. Another example of such a processing platform is processing platform 1200 shown in FIG. 12.

The processing platform 1200 in this embodiment comprises at least a portion of information processing systems 100, 200, and 300, and includes a plurality of processing devices, denoted 1202-1, 1202-2, 1202-3, . . . 1202-K, which communicate with one another over a network 1204.

The network 1204 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1202-1 in the processing platform 1200 comprises a processor 1210 coupled to a memory 1212.

The processor 1210 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1212 may comprise random access memory (RAM), read-only memory (ROM), flash memory or other types of memory, in any combination. The memory 1212 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1202-1 is network interface circuitry 1214, which is used to interface the processing device with the network 1204 and other system components, and may comprise conventional transceivers.

The other processing devices 1202 of the processing platform 1200 are assumed to be configured in a manner similar to that shown for processing device 1202-1 in the figure.

Again, the particular processing platform 1200 shown in the figure is presented by way of example only, and information processing system environments mentioned herein may include additional or alternative processing platforms, as well as numerous distinct processing platforms in any combination, with each such platform comprising one or more computers, servers, storage devices or other processing devices. For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for application monitoring with predictive anomaly detection and fault isolation as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, edge computing environments, applications, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing platform comprising at least one processor coupled to at least one memory, the at least one processing platform, when executing program code, is configured to:
receive a request to execute a task; and
manage execution of the task via one or more computational resources of a plurality of computational resources ordinarily used for executing other tasks wherein, when managing execution of the task, the at least one processing platform is further configured to:
receive one or more parameters representing one or more of a consent, a time period availability, and a computational resource capacity from each of the plurality of computational resources; and
identify the one or more computational resources of the plurality of computational resources able to execute the task based on the one or more parameters.

2. The apparatus of claim 1 wherein, when managing execution of the task, the at least one processing platform is further configured to register the task and the plurality of computational resources.

3. The apparatus of claim 1 wherein, when managing execution of the task, the at least one processing platform is further configured to cluster the task and the plurality of computational resources based on clustering criteria.

4. The apparatus of claim 1 wherein, when managing execution of the task, the at least one processing platform is further configured to calibrate the task to determine a minimum computational resource capacity and a maximum time to execute the task such that the identification of the one or more computational resources of the plurality of computational resources is further based on the calibration.

5. The apparatus of claim 1 wherein, when managing execution of the task, the at least one processing platform is further configured to cause deployment of a module on each of the plurality of computational resources, wherein the module is configured to facilitate managing execution of the task.

6. The apparatus of claim 1 wherein, when managing execution of the task, the at least one processing platform is further configured to cause deployment of a virtualization image on each of the one or more identified computational resources, wherein the virtualization image is configured to execute the task on each of the one or more identified computational resources.

7. The apparatus of claim 1 wherein, when managing execution of the task, the at least one processing platform is further configured to divide the task into sub tasks for parallel execution on the one or more identified computational resources.

8. The apparatus of claim 1 wherein, when managing execution of the task, the at least one processing platform is further configured to receive a heartbeat signal from each of the plurality of computational resources.

9. The apparatus of claim 1 wherein, when managing execution of the task, the at least one processing platform is further configured to:
aggregate results of execution of the task received from the one or more identified computational resources; and
send the aggregated results of execution to a source of the task request.

10. The apparatus of claim 1 wherein the processing platform is managed by an enterprise and the plurality of computational resources are devices respectively operated by employees of the enterprise such that the one or more identified computational resources are utilized to execute the task when the one or more identified computational resources are available based on the other tasks the one or more identified computational resources are ordinarily used for execute.

11. The apparatus of claim 1, wherein the at least one processing platform is configured with a dynamic compute controller and at least one distributed compute managers operatively coupled to the dynamic compute controller.

12. A method comprising:
receiving a request to execute a task; and
managing execution of the task via one or more computational resources of a plurality of computational resources ordinarily used for executing other tasks, wherein managing execution of the task further comprises:
receiving one or more parameters representing one or more of a consent, a time period availability, and a computational resource capacity from each of the plurality of computational resources; and
identifying the one or more computational resources of the plurality of computational resources able to execute the task based on the one or more parameters;
wherein the method is performed by at least one processing platform comprising at least one processor coupled to at least one memory, and the at least one processing platform being configured to execute program code.

13. The method of claim 12 wherein managing execution of the task further comprises registering the task and the plurality of computational resources.

14. The method of claim 12 wherein managing execution of the task further comprises clustering the task and the plurality of computational resources based on clustering criteria.

15. The method of claim 12 wherein managing execution of the task further comprises calibrating the task to determine a minimum computational resource capacity and a maximum time to execute the task such that the identification of the one or more computational resources of the plurality of computational resources is further based on the calibration.

16. The method of claim 12 wherein managing execution of the task further comprises causing deployment of a module on each of the plurality of computational resources, wherein the module is configured to facilitate managing execution of the task.

17. The method of claim 12 wherein managing execution of the task further comprises causing deployment of a virtualization image on each of the one or more identified computational resources, wherein the virtualization image is configured to execute the task on each of the one or more identified computational resources.

18. The method of claim 12 wherein managing execution of the task further comprises dividing the task into sub tasks for parallel execution on the one or more identified computational resources.

19. The method of claim 12 wherein managing execution of the task further comprises:
aggregating results of execution of the task received from the one or more identified computational resources; and
sending the aggregated results of execution to a source of the task request.

20. A computer program product comprising a non-transitory processor-readable storage medium having stored therein program code of one or more software programs, wherein the program code when executed by at least one processing platform causes the at least one processing platform to:
receive a request to execute a task; and
manage execution of the task via one or more computational resources of a plurality of computational resources ordinarily used for executing other tasks wherein, when managing execution of the task, the at least one processing platform is further configured to:
receive one or more parameters representing one or more of a consent, a time period availability, and a computational resource capacity from each of the plurality of computational resources; and
identify the one or more computational resources of the plurality of computational resources able to execute the task based on the one or more parameters.
